(19) United States
(12) Patent Application Publication
(10) Pub. No.: US 2024/0351867 A1
(43) Pub. Date: Oct. 24, 2024

(54) METHOD FOR PRODUCING HYDROGEN

(71) Applicant: NITTO DENKO CORPORATION, Ibaraki-shi, Osaka (JP)

(72) Inventors: Makoto HIRANO, Ibaraki-shi, Osaka (JP); Hirokazu MATSUDA, Ibaraki-shi, Osaka (JP)

(21) Appl. No.: 18/685,584

(22) PCT Filed: Aug. 9, 2022
(86) PCT No.: PCT/JP2022/030477

§ 371 Date: Feb. 22, 2024

(30) Foreign Application Priority Data
Aug. 24, 2021 (JP) 2021-136535

(51) Int. Cl. C01B 3/22; B01J 31/02; B01J 31/22

(52) U.S. Cl. CPC C01B 3/22; B01J 31/0239; B01J 31/2295; B01J 2231/76; B01J 2523/51; B01J 2523/821; C01B 2203/1064

(57) ABSTRACT

The present invention relates to a method for producing hydrogen, in which hydrogen is generated from a formate using a metal catalyst in the presence of a solvent by a two-phase system reaction in which the solvent is present in a state where an organic phase and an aqueous phase are separated.

### TECHNICAL FIELD

The present invention relates to a method for producing hydrogen.

### BACKGROUND ART

In view of global warming, depletion of fossil fuels, and the like, hydrogen energy is highly expected as the next-generation energy. In order to implement a hydrogen energy social, various techniques for producing, storing, and using hydrogen are required, but hydrogen storage has various problems such as storage, transport, safety, cycle, and cost.

Further, various materials such as hydrogen storage alloys, organic hydrides, inorganic hydrides, organic metal complexes, and porous carbon materials have been studied as hydrogen storage materials.

For example, organic hydrides have attracted attention because of advantages of ease of handling, high hydrogen storage density, and light weight.

As the organic hydride, hydrocarbon compounds such as formic acid, formate, benzene, toluene, biphenyl, naphthalene, cyclohexane, and methylcyclohexane are known. Among them, formic acid and formate have low energy required for a dehydrogenation reaction and may be easily handled, and thus are considered to be excellent compounds as a hydrogen storage material and have attracted attention.

On the other hand, hydrogen stored in a hydrogen storage material needs to be separated and recovered with high efficiency, and a method thereof has been studied.

For example, Patent Literature 1 describes a method for regenerating a catalyst by catalytically cracking a high-concentration aqueous potassium formate solution containing a catalyst in a reaction vessel to generate a potassium bicarbonate slurry and hydrogen, and treating a mixture containing the potassium bicarbonate slurry and the catalyst with an oxidizing agent. In addition, Patent Literature 2 describes a method for generating, using a catalyst, carbon dioxide and hydrogen gas from an aqueous solution containing formic acid.

### CITATION LIST

### Patent Literature

Patent Literature 1: JP2017-500272A

Patent Literature 2: JP2010-506818A

### SUMMARY OF INVENTION

### Technical Problem

In order to recover hydrogen stored in a hydrogen storage material with a high yield and excellent productivity, it is important to recover hydrogen without inactivating an expensive catalyst. However, in the methods described in Patent Literatures 1 and 2, the reaction is performed in a one-phase system, and therefore, a complicated operation is required for separating and recovering the catalyst, and there is a concern that the catalytic activity may decrease. In addition, in the technique described in Patent Literature 2, carbon dioxide is generated, and therefore, there is also a problem in handling carbon dioxide.

Therefore, the present invention provides a method for producing hydrogen capable of producing hydrogen from a formate with a high yield and excellent productivity.

### SOLUTION TO PROBLEM

As a result of intensive studies, the present inventors have found a method for producing hydrogen capable of producing hydrogen with a high yield and excellent productivity using a metal catalyst in the presence of a solvent by performing a reaction in a two-phase system in which the solvent is present in a state where an organic phase and an aqueous phase are separated, and have completed the present invention.

A solution to the above problems is as follows.

<1>

A method for producing hydrogen, in which

hydrogen is generated from a formate using a metal catalyst in the presence of a solvent by a two-phase system reaction in which the solvent is present in a state where an organic phase and an aqueous phase are separated.

<2>

The method for producing hydrogen according to <1>, in which

a phase transfer catalyst is used for the reaction.

<3>

The method for producing hydrogen according to <2>, in which

the phase transfer catalyst is a quaternary ammonium salt.

<4>

The method for producing hydrogen according to any one of <1>to <3>, in which

the metal catalyst contains at least one metal selected from ruthenium, iridium, iron, nickel, and cobalt.

<5>

The method for producing hydrogen according to any one of <1>to <4>, in which

the metal catalyst is at least one selected from a ruthenium complex represented by the following general formula (1), a tautomer or stereoisomer thereof, and a salt compound of the complex, tautomer or stereoisomer:

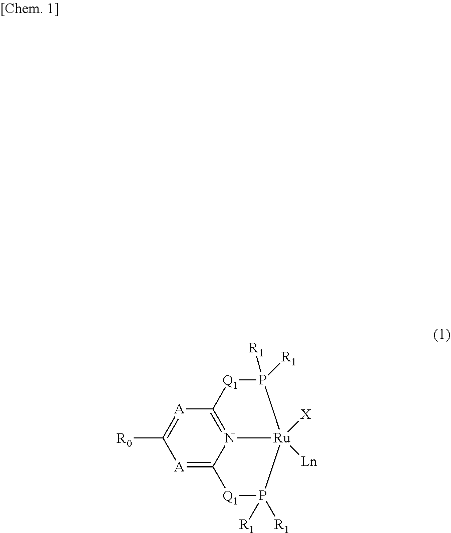

(in the general formula (1), R₀ represents a hydrogen atom or an alkyl group, Q₁ each independently represents CH₂, NH or O, R₁ each independently represents an alkyl group or an aryl group (when Q₁ represents NH or O, at least one of R₁ represents an aryl group), A each independently represents CH, CR₅ or N, R₅ represents an alkyl group, an aryl group, an aralkyl group, an amino group, a hydroxy group, or an alkoxy group, X represents a halogen atom, n represents 0 to 3, and when more than one L are present, L each independently represents a neutral or anionic ligand.)

<6>

The method for producing hydrogen according to any one of <1>to <5>, in which

the formate is a sodium formate or a potassium formate.

<7>

The method for producing hydrogen according to any one of <1>to <6>, in which

the organic phase contains at least one selected from toluene, dioxane, tetrahydrofuran, ethyl acetate, methylcyclohexane, and cyclopentyl methyl ether.

### ADVANTAGEOUS EFFECTS OF INVENTION

According to the present invention, it is possible to provide a method for producing hydrogen that is capable of producing hydrogen from a formate with a high yield and excellent productivity.

### DESCRIPTION OF EMBODIMENTS

Hereinafter, embodiments of the present invention will be described in detail.

A method for producing hydrogen according to an embodiment of the present invention relates to a method of generating hydrogen from a formate using a metal catalyst in the presence of a solvent by a two-phase system reaction in which the solvent is present in a state where an organic phase and an aqueous phase are separated.

The reaction in the method for producing hydrogen according to the embodiment of the present invention is a formate decomposition reaction, and by the above reaction, a carbonate is generated together with hydrogen from the formate.

In the method for producing hydrogen according to the embodiment of the present invention, the reaction for generating hydrogen from a formate is preferably performed by a reaction of a two-phase system using an aqueous formate solution as an aqueous phase and a catalyst solution in which a metal catalyst (hereinafter, simply referred to as a catalyst in some cases) is dissolved in an organic solvent as an organic phase.

In addition, in the method for producing hydrogen according to the embodiment of the present invention, a phase transfer catalyst is preferably used in the reaction.

According to the method for producing hydrogen according to the embodiment of the present invention, hydrogen can be produced from a formate with a high yield and excellent productivity.

Hydrogen generated by the reaction may be taken out of the reaction system as a gas. Therefore, it is possible to prevent the hydrogen generation reaction from being stopped due to equilibrium, and to generate hydrogen from a formate with a high yield.

Furthermore, in the method according to the embodiment of the present invention, the reaction proceeds in a two-phase system, and therefore, the carbonate generated together with hydrogen can be obtained in a state of being dissolved in an aqueous phase as an aqueous carbonate solution. Therefore, there is an advantage that it is possible to extract only hydrogen as a gas from the formate while storing the carbon dioxide as a carbonate in an aqueous phase, not as a gas.

In addition, when a metal catalyst such as a homogeneous catalyst which is easily soluble in an organic solvent is used, the unreacted formate, hydrogen, and carbonate can be separated from the metal catalyst by separating the organic phase and the aqueous phase. By separating the organic phase from the aqueous phase as a solution containing the metal catalyst by liquid separation, the recovery can be performed while preventing deactivation of the expensive metal catalyst, and therefore, the expensive catalyst can be reused, and high productivity can be implemented.

The reaction in the method for producing hydrogen according to the embodiment of the present invention can be performed, for example, as follows.

A reaction vessel equipped with a stirring device is prepared. A formate dissolved in an aqueous solvent and a homogeneous catalyst solution dissolved in an organic solvent are added to the reaction vessel. If necessary, a phase transfer catalyst may be further added. Further, a reaction is preferably performed by stirring and heating a reaction mixture in the reaction vessel.

Hereinafter, the solvent, the formate, the metal catalyst, reaction conditions, and the like used for the reaction will be described.

### Solvent

The solvent used in the embodiment of the present invention is not particularly limited as long as the solvent may be a two-phase system in which a reaction solution is present in a state where an organic phase and an aqueous phase are separated, and preferably contains a solvent that dissolves a catalyst to be uniform.

The organic phase is a phase containing an organic solvent as a solvent, and the aqueous phase is a phase containing an aqueous solvent as a solvent.

Examples of the aqueous solvent include water, methanol, ethanol, ethylene glycol, glycerin, and a mixed solvent thereof, and water is preferable from the viewpoint of low environmental load.

Examples of the organic solvent include toluene, benzene, xylene, propylene carbonate, dioxane, dimethyl sulfoxide, tetrahydrofuran, ethyl acetate, methylcyclohexane, cyclopentyl methyl ether, and a mixed solvent thereof, at least one selected from toluene, dioxane, tetrahydrofuran, ethyl acetate, methylcyclohexane, and cyclopentyl methyl ether is preferable, and toluene or dioxane is more preferable from the viewpoint of separability from the aqueous solvent. That is, the organic phase preferably contains at least one selected from toluene, dioxane, tetrahydrofuran, ethyl acetate, methylcyclohexane, and cyclopentyl methyl ether, more preferably contains toluene or dioxane, and still more preferably contains toluene.

### Formate

The formate used in the embodiment of the present invention is not particularly limited as long as it may generate hydrogen by an action of the catalyst, and is preferably dissolved in the aqueous phase. Examples thereof include an alkali metal formate and an alkaline earth metal formate.

Examples of the alkali metal formate include a lithium formate, a sodium formate, a potassium formate, a rubidium formate, a cesium formate, and a francium formate.

Examples of the alkaline earth metal formate include a calcium formate, a strontium formate, a barium formate, and a radium formate.

As the formate used in the embodiment of the present invention, a potassium formate or a sodium formate is preferable from the viewpoint of raw material procurement.

In the embodiment of the present invention, the formate is preferably dissolved in the aqueous phase. An amount of the formate used is preferably 0.05 mol or more, more preferably 0.5 mol or more, and still more preferably 1 mol or more with respect to 1 L of the aqueous solvent. The formate to be used does not need to be completely dissolved, and a part thereof may be present as a solid in a reaction mixture.

### Metal Catalyst

The catalyst used in the embodiment of the present invention is a metal catalyst. The metal catalyst is preferably a compound containing a metal element (metal element compound).

In addition, the metal catalyst used in the embodiment of the present invention is preferably a homogeneous catalyst, and is preferably dissolved in the organic solvent.

Examples of the metal element compound include a salt of a metal element with an inorganic acid, such as a hydride salt, an oxysalt, a halide salt (chloride salt or the like), a hydroxide salt, a carbonate, a hydrogen carbonate, a sulfate, a nitrate, a phosphate, a borate, a halide, a perhalide, a halite, a hypohalite, and a thiocyanate; a salt with an organic acid, such as an alkoxide salt, carboxylate (acetate, (meth)acrylate, and the like), and a sulfonate (trifluoromethanesulfonate and the like); a salt with an organic base, such as an amide salt, a sulfonamide salt, and a sulfonimide salt (bis(trifluoromethanesulfonyl) imide salt and the like); a complex salt such as an acetyl acetone salt, a hexafluoroacetyl acetone salt, a porphyrin salt, a phthalocyanine salt, and a cyclopentadiene salt; and a complex including one or more of a nitrogen compound containing a chain amine, a cyclic amine, an aromatic amine, and the like, a phosphorus compound, a compound containing phosphorus and nitrogen, a sulfur compound, carbon monoxide, carbon dioxide, and water, and salts thereof. These compounds may be any of hydrates and anhydrides, and are not particularly limited. Among them, a halide salt, a complex containing a phosphorus compound, a complex containing a nitrogen compound, and a complex containing a compound containing phosphorus and nitrogen or a salt thereof are preferable from the viewpoint of further enhancing a hydrogen generation efficiency.

These may be used alone or in combination of two or more types thereof.

A commercially available metal element compound can be used, and a metal element compound produced by a known method or the like can also be used. As a known method, for example, a method described in Japanese Patent No. 5896539, or a method described in Chem. Rev. 2017, 117, 9804-9838 and Chem. Rev. 2018, 118, 372-433 can be used.

The metal catalyst used in the method for producing hydrogen according to the embodiment of the present invention preferably contains at least one metal selected from ruthenium, iridium, iron, nickel, and cobalt, and preferably contains ruthenium. Among them, at least one selected from the ruthenium complex represented by the general formula (1), a tautomer or stereoisomer thereof, and a salt compound of the complex, tautomer or stereoisomer is preferable.

The ruthenium complex represented by the general formula (1) is soluble in an organic solvent and insoluble in water. Hydrogen generated by a reaction can be separated as a gas from a system, carbonate generated together with hydrogen is easily dissolved in water, and therefore, the catalyst and the carbonate are easily separated by the reaction in the two-phase system. Therefore, the catalyst, hydrogen, and carbonate may be easily separated and recovered from the reaction system, and hydrogen may be produced at a high yield.

With the method according to the present embodiment, hydrogen generated by the reaction, the carbonate, and the catalyst can be separated by a simple operation, and the expensive catalyst and the carbonate can be reused.

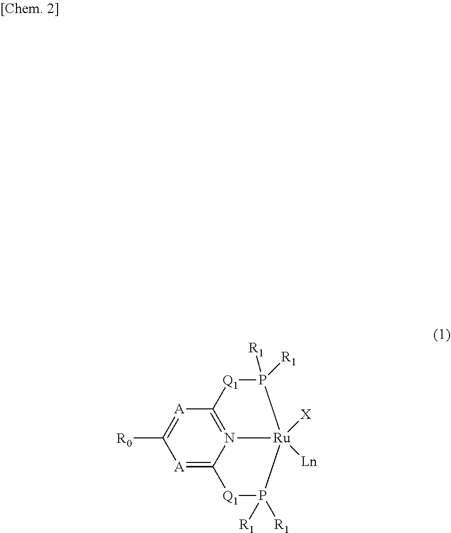

(in the general formula (1), R₀ represents a hydrogen atom or an alkyl group, Q₁ each independently represents CH₂, NH or O, R₁ each independently represents an alkyl group or an aryl group (when Q₁ represents NH or O, at least one of R₁ represents an aryl group), A each independently represents CH, CR₅ or N, R₅ represents an alkyl group, an aryl group, an aralkyl group, an amino group, a hydroxy group, or an alkoxy group, X represents a halogen atom, n represents 0 to 3, and when more than one L are present, L each independently represents a neutral or anionic ligand.)

R₀ in the general formula (1) represents a hydrogen atom or an alkyl group. Examples of the alkyl group represented by R₀ include a linear, branched, or cyclic substituted or unsubstituted alkyl group.

The alkyl group represented by R₀ is preferably an alkyl group having one carbon atom to 30 carbon atoms, such as a methyl group, an ethyl group, an n-propyl group, an i-propyl group, a t-butyl group, an n-octyl group, an eicosyl group, or a 2-ethylhexyl group, is preferably an alkyl group having six or less carbon atoms from the viewpoint of ease of raw material procurement, and is preferably a methyl group.

R₀ in the general formula (1) is preferably a hydrogen atom or a methyl group.

R₁ in the general formula (1) each independently represents an alkyl group or an aryl group. When Q₁ represents NH or O, at least one R₁ represents an aryl group.

Examples of the alkyl group represented by R₁ include a linear, branched, or cyclic substituted or unsubstituted alkyl group. The alkyl group represented by R₁ is preferably an alkyl group having 1 carbon atom to 30 carbon atoms, such as a methyl group, an ethyl group, an n-propyl group, an i-propyl group, a t-butyl group, an n-octyl group, an eicosyl group, or a 2-ethylhexyl group, is preferably an alkyl group having 12 or less carbon atoms from the viewpoint of catalyst activity, and is preferably a t-butyl group.

Examples of the aryl group represented by R₁ include a substituted or unsubstituted aryl group having 6 carbon atoms to 30 carbon atoms, such as a phenyl group, a p-tolyl group, a naphthyl group, an m-chlorophenyl group, or an o-hexadecanoylaminophenyl group, and the aryl group represented by R₁ is preferably an aryl group having 12 or less carbon atoms, and more preferably a phenyl group.

A each independently represents CH, CR₅ or N, and R₅ represents an alkyl group, an aryl group, an aralkyl group, an amino group, a hydroxy group or an alkoxy group.

Examples of the alkyl group represented by R₅ include a linear, branched, or cyclic substituted or unsubstituted alkyl group. The alkyl group represented by R₅ is preferably an alkyl group having 1 carbon atom to 30 carbon atoms, such as a methyl group, an ethyl group, an n-propyl group, an i-propyl group, a t-butyl group, an n-octyl group, an eicosyl group, or a 2-ethylhexyl group, is preferably an alkyl group having 12 or less carbon atoms from the viewpoint of ease of raw material procurement, and is preferably a methyl group.

Examples of the aryl group represented by R₅ include a substituted or unsubstituted aryl group having 6 carbon atoms to 30 carbon atoms, such as a phenyl group, a p-tolyl group, a naphthyl group, an m-chlorophenyl group, or an o-hexadecanoylaminophenyl group, and the aryl group represented by R₅ is preferably an aryl group having 12 or less carbon atoms, and more preferably a phenyl group.

Examples of the aralkyl group represented by R₅ include a substituted or unsubstituted aralkyl group having 30 or less carbon atoms, such as a trityl group, a benzyl group, a phenethyl group, a trityl methyl group, a diphenyl methyl group, or a naphthylmethyl group, and the aralkyl group represented by R₅ is preferably an aralkyl group having 12 or less carbon atoms.

The alkoxy group represented by R₅ is preferably a substituted or unsubstituted alkoxy group having 1 carbon atom to 30 carbon atoms, and examples thereof include a methoxy group, an ethoxy group, an isopropoxy group, a t-butoxy group, an n-octyloxy group, and a 2-methoxyethoxy group.

X represents a halogen atom, preferably a chlorine atom.

n represents an integer of 0 to 3, and represents the number of ligands coordinated to ruthenium. n is preferably 2 or 3 from the viewpoint of stability of the catalyst.

When more than one L are present, L each independently represents a neutral or anionic ligand.

Examples of the neutral ligand represented by L include ammonia, carbon monoxide, phosphines (for example, triphenylphosphine, tris(4-methoxyphenyl) phosphine), phosphine oxides (for example, triphenylphosphine oxide), sulfides (for example, dimethyl sulfide), sulfoxides (for example, dimethyl sulfoxide), ethers (for example, diethyl ether), nitriles (for example, p-methyl benzonitrile), and heterocyclic compounds (for example, pyridine, N,N-dimethyl-4-aminopyridine, tetrahydrothiophene, and tetrahydrofuran), and the neutral ligand represented by L is preferably triphenylphosphine.

Examples of the anionic ligand represented by L include a hydride ion (hydrogen atom), a nitrate ion, and a cyanide ion, and the anionic ligand represented by L is preferably a hydride ion (hydrogen atom).

In the general formula (1), it is preferable that A represents CH and Q₁ represents NH.

In addition, it is preferable that n represents 1 to 3, and L each independently represents a hydrogen atom, carbon monoxide or triphenylphosphine.

The ruthenium complex represented by the general formula (1) may be used alone or in combination of two or more types thereof.

The ruthenium complex represented by the general formula (1) is preferably a ruthenium complex represented by the following general formula (3).

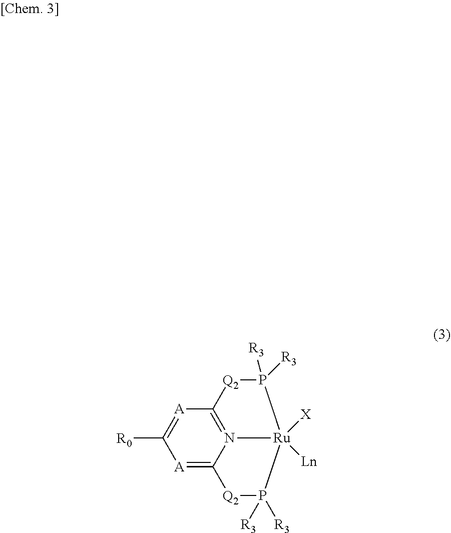

(In the general formula (3), R₀ represents a hydrogen atom or an alkyl group, Q₂ each independently represents NH or O, R₃ each independently represents an aryl group, A each independently represents CH, CR₅ or N, R₅ represents an alkyl group, an aryl group, an aralkyl group, an amino group, a hydroxy group or an alkoxy group, X represents a halogen atom, n represents 0 to 3, and when more than one L are present, L each independently represents a neutral or anionic ligand.)

R₀, A, R₅, X, n, and L in the general formula (3) have the same meanings as R₀, A, R₅, X, n, and L in the general formula (1), respectively, and preferred ranges thereof are also the same.

The aryl group represented by R₃ in the general formula (3) has the same meaning as the aryl group represented by R₁ in the general formula (1), and a preferred range is also the same.

The ruthenium complexes represented by the general formula (1) and the general formula (3) may be produced by a known method or the like. As a known method, for example, a method described in E.Pidko et al., ChemiCatChem 2014, 6, 1526 to 1530 or the like can be used.

The ruthenium complexes represented by the general formula (1) and the general formula (3) may produce stereoisomers depending on a coordination mode and conformation of a ligand, and may be a mixture of the stereoisomers or a single pure isomer.

Specific examples of the metal catalyst (preferably the ruthenium complexes represented by the general formula (1) and the general formula (3)) and the ligand according to the embodiment of the present invention include the following compounds.

In the compounds exemplified below, tBu represents a tertiary butyl group, and Ph represents a phenyl group.

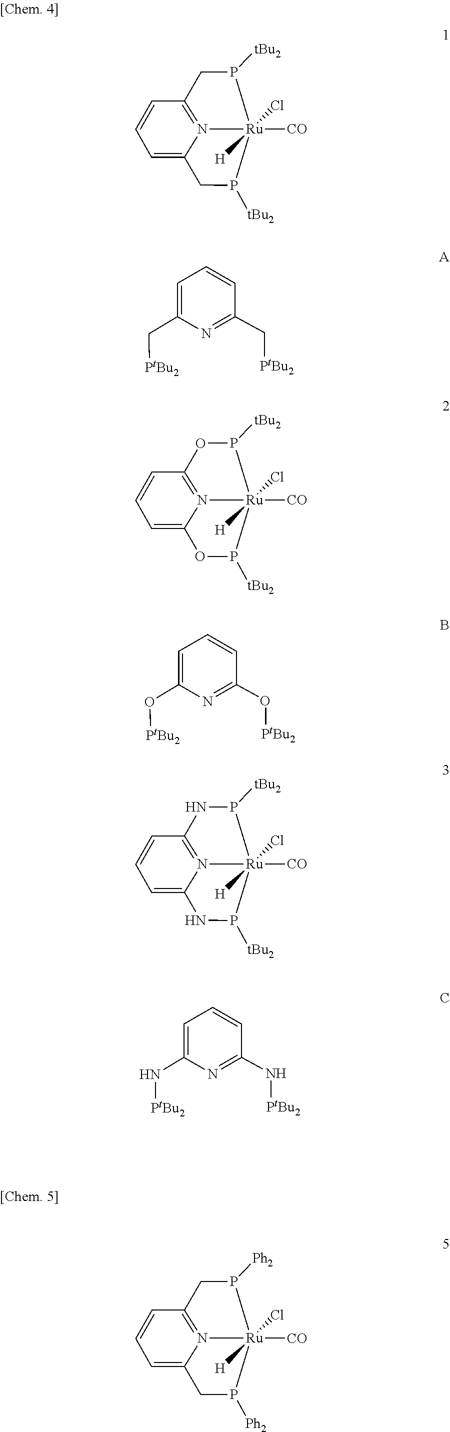

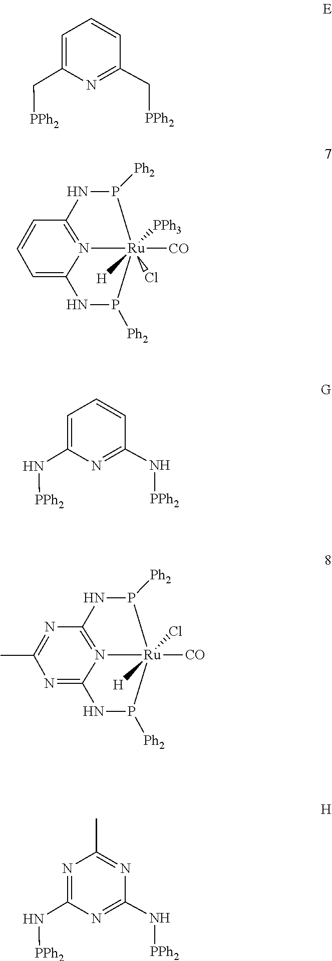

An amount of the metal catalyst used is not particularly limited as long as hydrogen can be produced.

The amount of the metal catalyst used is preferably 0.1 μmol or more, more preferably 0.5 μmol or more, and still more preferably 1 μmol or more with respect to 1 L of the solvent in order to sufficiently express a catalytic function. In addition, the amount of the metal catalyst used is preferably 1 mol or less, more preferably 10 mmol or less, and still more preferably 1 mmol or less, from the viewpoint of cost.

When two or more types of metal catalysts are used, a total amount of the metal catalysts used may be within the above range.

In the method for producing hydrogen according to the embodiment of the present invention, it is preferable that the metal catalyst is a metal complex catalyst and that a ligand of the metal complex catalyst is excessively present in the reaction mixture. Therefore, it is preferable to further add a ligand of the metal complex to be used.

That is, in the method for producing hydrogen according to the embodiment of the present invention, it is preferable that the metal catalyst is a metal complex catalyst and that a ligand of the metal complex catalyst is further added. For example, when the metal catalyst is the ruthenium complex represented by the general formula (1), a ligand represented by the following general formula (4) is preferably further added.

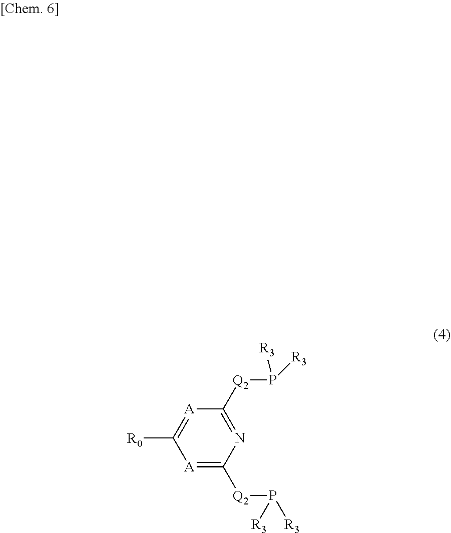

(In the general formula (4), R₀ represents a hydrogen atom or an alkyl group, Q₂ each independently represents NH or O, R₃ each independently represents an aryl group, A each independently represents CH, CR₅ or N, and R₅ represents an alkyl group, an aryl group, an aralkyl group, an amino group, a hydroxy group or an alkoxy group.)

R₀, Q₂, R₃, A, and R₅ in the general formula (4) have the same meanings as R₀, Q₂, R₃, A, and R₅ in the general formula (3), respectively, and preferred ranges thereof are also the same.

By excessively adding a ligand forming a complex to the reaction system, even when the ligand is oxidized and deteriorated due to oxygen or impurities contained in the system, the deteriorated ligand and the added ligand are exchanged, the catalytic function is restored, and therefore, the stability of the metal catalyst can be improved.

### Phase Transfer Catalyst

In the method for producing hydrogen according to the embodiment of the present invention, the reaction needs to be performed in a two-phase system, and therefore, a phase transfer catalyst may be used to smooth transfer of a substance between two phases. Examples of the phase transfer catalyst include a quaternary ammonium salt, a quaternary phosphate, a macrocyclic polyether such as a crown ether, a nitrogen-containing macrocyclic polyether such as cryptand, a nitrogen-containing chain polyether, polyethylene glycol, and an alkyl ether thereof. Among them, a quaternary ammonium salt is preferable from the viewpoint of ease of substance transfer between the aqueous solvent and the organic solvent even under mild reaction conditions.

Examples of the quaternary ammonium salt include methyltrioctylammonium chloride, benzyltrimethylammonium chloride, trimethylphenylammonium bromide, tributylammonium tribromide, tetrahexylammonium hydrogen sulfate, decyltrimethylammonium bromide, diallyldimethylammonium chloride, dodecyltrimethylammonium bromide, dimethyldioctadecylammonium bromide, tetraethylammonium tetrafluoroborate, ethyltrimethylammonium iodide tris(2-hydroxyethyl) methylammonium hydroxide, tetramethylammonium acetate, tetramethylammonium bromide, and tetraethylammonium iodide, and methyltrioctylammonium chloride is preferable.

An amount of the phase transfer catalyst used is not particularly limited as long as hydrogen can be produced. The amount of the phase transfer catalyst used is preferably 0.1 mmol or more, more preferably 0.5 mmol or more, and still more preferably 1 mmol or more with respect to 1 L of the solvent in order to improve the reaction rate. In addition, the amount of the phase transfer catalyst used is preferably 1 mol or less, more preferably 500 mmol or less, and still more preferably 100 mmol or less, from the viewpoint of cost.

When two or more types of phase transfer catalysts are used, a total amount of the phase transfer catalysts used may be within the above range.

### Reaction Conditions

As described above, the reaction according to the embodiment of the present invention can be performed, for example, as follows.

A reaction vessel equipped with a stirring device is prepared. A formate dissolved in an aqueous solvent and a homogeneous catalyst solution dissolved in an organic solvent are added to the reaction vessel. If necessary, a phase transfer catalyst may be further added. Further, the reaction is preferably performed by stirring and heating a reaction mixture in the reaction vessel.

By stirring the reaction mixture in the reaction vessel, an interface between the aqueous phase and the organic phase is increased, and the formate and the metal catalyst are easily brought into contact with each other. As a result, a hydrogen generation reaction proceeds more easily, and a catalyst turnover number (TON) increases, which is preferable.

Reaction conditions in the method for producing hydrogen according to the embodiment of the present invention are not particularly limited, and the reaction conditions can be appropriately changed in a reaction process. A form of the reaction vessel used for the reaction is not particularly limited.

A reaction temperature is not particularly limited, and is preferably 30° C. or higher, more preferably 40° C. or higher, and still more preferably 50° C. or higher in order to efficiently progress the reaction. In addition, the temperature is preferably 200° C. or lower, more preferably 150° C. or lower, and still more preferably 100° C. or lower, from the viewpoint of energy efficiency.

When the reaction temperature is 100° C. or lower, generation of carbon dioxide due to decomposition of carbonate can be prevented, and the carbonate can be obtained in a state of being dissolved in an aqueous solution.

A reaction time is not particularly limited, and is, for example, preferably 0.5 hours or longer, more preferably 1 hour or longer, and still more preferably 2 hours or longer, from the viewpoint of sufficiently ensuring the amount of hydrogen generated. In addition, the time is preferably 7 days or shorter, more preferably 4 days or shorter, and still more preferably 2 days or shorter, from the viewpoint of cost.

In the embodiment of the present invention, it is preferable that hydrogen generated by the reaction is taken out of the system as a mixed gas containing hydrogen gas. The mixed gas is not particularly limited, and may be purified by, for example, a gas separation membrane, gas-liquid separation, or a pressure swing adsorption (PSA) method.

As described above, in the method according to the embodiment of the present invention, the reaction proceeds in the two-phase system, and therefore, the carbonate generated together with hydrogen can be obtained in a state of being present in the aqueous phase. Therefore, when a metal catalyst such as a homogeneous catalyst which is easily soluble in an organic solvent is used, the unreacted formate, hydrogen, and carbonate can be separated from the metal catalyst by separating the organic phase and the aqueous phase. By separating the organic phase from the aqueous phase as a solution containing a metal catalyst by liquid separation, the recovery can be performed while preventing deactivation of the expensive metal catalyst.

A method of liquid separation is not particularly limited, and a general method is used. For example, liquid separation can be performed by taking out either the organic phase or the aqueous phase in an inert gas using a drain port of the reaction vessel, an attached pump, or the like.

The separated and recovered metal catalyst can be reused for the hydrogen generation reaction. For example, a solution containing the separated metal catalyst may be reused as it is for the hydrogen generation reaction, a concentration of the metal catalyst may be adjusted by an operation such as concentration or purification, or the metal catalyst may be isolated, recovered, and reused.

In addition, the carbonate separated and recovered in a state of being dissolved in the aqueous phase can be reused for production of a formate or the like by an operation such as concentration or purification.

### EXAMPLES

Hereinafter, the present invention will be described in detail with reference to Examples and Comparative Examples. However, the present invention is not limited to these examples.

### Synthesis of Catalyst

### Synthesis Example 1

### Synthesis of Ru Catalyst 1

An Ru catalyst 1 was synthesized by the following operations.

In an inert atmosphere, 40 mg (0.1 mmol) of the following ligand A was added to a tetrahydrofuran (THF) suspension (5 ml) of 95.3 mg (0.1 mmol) of [RuHCl(PPh₃)₃(CO)], and the mixture was stirred and heated at 65° C. for 3 hours for reaction. Thereafter, the temperature was cooled to room temperature (25° C.).

The obtained yellow solution was filtered, and the filtrate was evaporated and dried under vacuum. The obtained yellow residual oil was dissolved in a very small amount of THF (1 mL), and hexane (10 mL) was slowly added to precipitate a yellow solid, followed by filtering and drying under vacuum to obtain the Ru catalyst 1 (55 mg, 97%) as yellow crystals. In the Ru catalyst 1 and the ligand A shown below, tBu represents a tertiary butyl group.

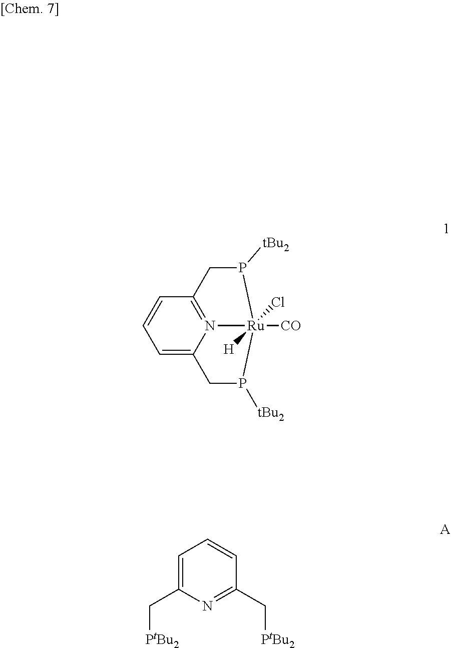

³¹P{¹H} (C₆D₆): 90.8 (s), ¹H (C₆D₆): −14.54 (t, 1H, J=20.0 Hz), 1.11 (t, 18H, J=8.0 Hz), 1.51 (t, 18H, J=8.0 Hz), 2.88 (dt, 2H, J=16.0 Hz, J=4.0 Hz), 3.76 (dt, 2H, J=16.0 Hz, J=4.0 Hz), 6.45 (d, 2H, J=8.0 Hz), 6.79 (t, 1H, J=8.0 Hz). ¹³C{¹H}NMR(C₆D₆): 29.8 (s), 30.7 (s), 35.2 (t, J=9.5 Hz), 37.7 (t, J=6.0 Hz), 37.9 (t, J=6.5 Hz), 119.5 (t, J=4.5 Hz), 136.4 (s), 163.4 (t, J=5.0 Hz), 209.8 (s).

### Synthesis Example 2

### Synthesis of Ru Catalyst 7

An Ru catalyst 7 was synthesized by the following operations.

In an inert atmosphere, 142.6 mg of a ligand G and 284.6 mg of [RuHCl(PPh₃)₃(CO)] were mixed with 5 mL of benzene, and the suspension was refluxed overnight. The generated yellow precipitate was collected on a filter and washed four times with 5 mL of ether.

The precipitate was dried in vacuum to obtain 154.0 mg of the Ru catalyst 7.

In the Ru catalyst 7 and the ligand G shown below, Ph represents a phenyl group.

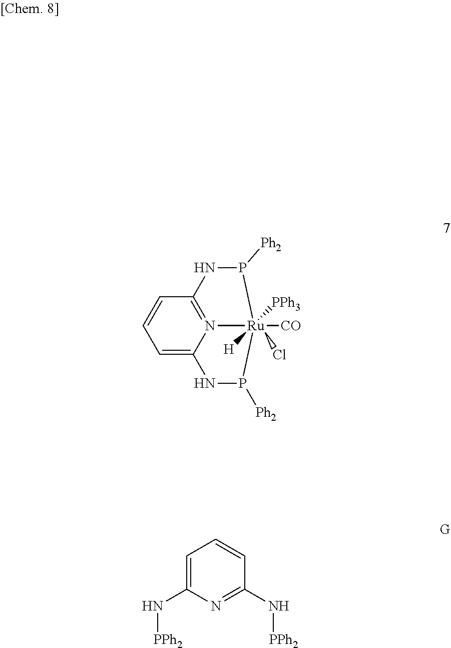

³¹P{1H}NMR(CDC₃): 95.58 (br, s), 29.71 (s).¹H

NMR(400 MHZ, CD₂Cl₂) 89.92 (s, 2H), 8.11 (q, J=6.6 Hz, 4H), 7.38-7.24 (m, 4H), 7.20 (t, J=7.5 Hz, 3H), 7.16-7.04 (m, 4H), 7.04-6.92 (m, 14H), 6.87 (td, J=7.6, 2.1 Hz, 6H), 6.51 (d, J=8.0 Hz, 1H), 6.61 (d, J=8.0 Hz, 2H), −7.22 (dt, J=89.2, 23.1 Hz, 1H).

### Formate Decomposition Reaction

### Example 1

In a glovebox under an inert gas, 5 mL of water and 20 mmol of a potassium formate were added to a glass vial equipped with a stirring rod, and then 20 mL of toluene, 5 μmol of an Ru catalyst 1, and 1.1 mmol of methyltrioctylammonium chloride were added thereto. The glass vial was placed in an autoclave, and the autoclave was sealed and taken out of the glovebox.

Thereafter, a stopper of the autoclave was opened, and the reaction mixture was heated to 60° C. and stirred at 800 rpm for 3 hours to perform a formate decomposition reaction. In addition, a mixed gas containing a gas generated by formate decomposition was collected in a Tedlar bag.

After the reaction, an organic phase (solution containing a catalyst) as an upper phase of a solution was separated to remove toluene, and an aqueous solution (aqueous phase) as a lower phase containing potassium hydrogen carbonate and unreacted potassium formate remained. By this operation, a metal catalyst could be separated from potassium hydrogen carbonate and potassium formate.

100 μL of the aqueous solution as the lower phase was taken and dissolved in 500 μL of deuterated water, 300 μL of dimethyl sulfoxide was added as an internal standard, and thereafter, TON of the catalyst was calculated by ¹H NMR measurement. As a result, the TON of the catalyst was 3,021.

### Example 2

In a glovebox under an inert gas, 5 mL of water and 20 mmol of a potassium formate were added to a glass vial equipped with a stirring rod, and then 20 mL of toluene, 5 μmol of an Ru catalyst 7, and 1.1 mmol of methyltrioctylammonium chloride were added thereto. The glass vial was placed in an autoclave, and the autoclave was sealed and taken out of the glovebox.

Thereafter, a stopper of the autoclave was opened, and the reaction mixture was heated to 60° C. and stirred at 800 rpm for 3 hours to perform a formate decomposition reaction.

After the reaction, an organic phase (solution containing a catalyst) as an upper phase of a solution was separated to remove toluene, and an aqueous solution (aqueous phase) as a lower phase containing potassium hydrogen carbonate and unreacted potassium formate remained. By this operation, a metal catalyst could be separated from potassium hydrogen carbonate and potassium formate.

100 μL of the aqueous solution as the lower phase was taken and dissolved in 500 μL of deuterated water, 300 μL of dimethyl sulfoxide was added as an internal standard, and thereafter, TON of the catalyst was calculated by ¹H NMR measurement. As a result, the TON of the catalyst was 1,097.

### Example 3

In a glovebox under an inert gas, 5 mL of water and 20 mmol of a potassium formate were added to a glass vial equipped with a stirring rod, and then 20 mL of toluene, an Ru catalyst 10 represented by the following formula (5 μmol of benzene ruthenium (II) chloride (dimer) and 30 μmol of bis (diphenylphosphino)methane), and 1.1 mmol of methyltrioctylammonium chloride were added thereto. The vial was placed in an autoclave, and the autoclave was sealed and taken out of the glovebox. The glass vial was placed in an autoclave, and the autoclave was sealed and taken out of the glovebox.

Thereafter, a stopper of the autoclave was opened, and the reaction mixture was heated to 60° C. and stirred at 800 rpm for 3 hours to perform a formate decomposition reaction.

After the reaction, an organic phase (solution containing a catalyst) as an upper phase of a solution was separated to remove toluene, and an aqueous solution (aqueous phase) as a lower phase containing potassium hydrogen carbonate and unreacted potassium formate remained. By this operation, a metal catalyst could be separated from potassium hydrogen carbonate and potassium formate.

100 μL of the aqueous solution (aqueous phase) as the lower phase was taken and dissolved in 500 μL of deuterated water, 300 μL of dimethyl sulfoxide was added as an internal standard, and thereafter, TON of the catalyst was calculated by ¹H NMR measurement. As a result, the TON of the catalyst was 945.

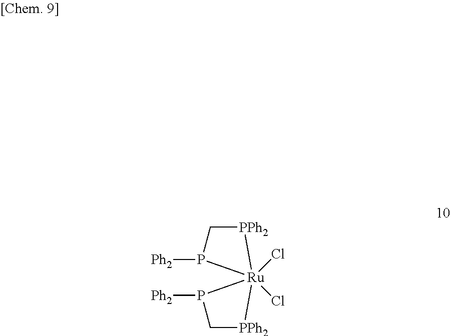

### Example 4

In a glovebox under an inert gas, 5 mL of water and 20 mmol of a sodium formate were added to a glass vial equipped with a stirring rod, and then 20 mL of toluene, 5 μmol of an Ru catalyst 1, and 1.1 mmol of methyltrioctylammonium chloride were added thereto. The glass vial was placed in an autoclave, and the autoclave was sealed and taken out of the glovebox.

Thereafter, a stopper of the autoclave was opened, and the reaction mixture was heated to 60° C. and stirred at 800 rpm for 3 hours to perform a formate decomposition reaction.

After the reaction, an organic phase (solution containing a catalyst) as an upper phase of the solution was separated to remove toluene, and an aqueous solution (aqueous phase) as a lower phase containing sodium hydrogen carbonate and unreacted sodium formate remained. By this operation, the metal catalyst could be separated from sodium hydrogen carbonate and sodium formate. 100 μL of the aqueous solution as the lower phase was taken and dissolved in 500 μL of deuterated water, 300 μL of dimethyl sulfoxide was added as an internal standard, and thereafter, TON of the catalyst was calculated by ¹H NMR measurement. As a result, the TON of the catalyst was 2,944.

### Example 5

In a glovebox under an inert gas, 5 mL of water and 20 mmol of a potassium formate were added to a glass vial equipped with a stirring rod, and then 20 mL of toluene and 5 μmol of an Ru catalyst 1 were added thereto. The glass vial was placed in an autoclave, and the autoclave was sealed and taken out of the glovebox.

Thereafter, a stopper of the autoclave was opened, and the reaction mixture was heated to 60° C. and stirred at 800 rpm for 3 hours to perform a formate decomposition reaction.

After the reaction, an organic phase (solution containing a catalyst) as an upper phase of a solution was separated to remove toluene, and an aqueous solution (aqueous phase) as a lower phase containing potassium hydrogen carbonate and unreacted potassium formate remained. By this operation, a metal catalyst could be separated from potassium hydrogen carbonate and potassium formate.

100 μL of the aqueous solution as the lower phase was taken and dissolved in 500 μL of deuterated water, 300 μL of dimethyl sulfoxide was added as an internal standard, and thereafter, TON of the catalyst was calculated by ¹H NMR measurement. As a result, the TON of the catalyst was 705.

### Example 6

In a glovebox under an inert gas, 5 mL of water and 20 mmol of a potassium formate were added to a glass vial equipped with a stirring rod, and then 20 mL of toluene and an Ru catalyst 10 (5 μmol of benzene ruthenium (II) chloride (dimer) and 30 μmol of bis (diphenylphosphino)methane) were added thereto. The glass vial was placed in an autoclave, and the autoclave was sealed and taken out of the glovebox. The glass vial was placed in an autoclave, and the autoclave was sealed and taken out of the glovebox.

Thereafter, a stopper of the autoclave was opened, and the reaction mixture was heated to 60° C. and stirred at 800 rpm for 3 hours to perform a formate decomposition reaction.

After the reaction, an organic phase (solution containing a catalyst) as an upper phase of a solution was separated to remove toluene, and an aqueous solution (aqueous phase) as a lower phase containing potassium hydrogen carbonate and unreacted potassium formate remained. By this operation, a metal catalyst could be separated from potassium hydrogen carbonate and potassium formate.

100 μL of the aqueous solution as the lower phase was taken and dissolved in 500 μL of deuterated water, 300 μL of dimethyl sulfoxide was added as an internal standard, and thereafter, TON of the catalyst was calculated by ¹H NMR measurement. As a result, the TON of the catalyst was 867.

### Comparative Example 1

In a glovebox under an inert gas, 5 mL of water and 20 mmol of a potassium formate were added to a glass vial equipped with a stirring rod, and then 20 mL of dimethylformamide (DMF), an Ru catalyst 10 (5 μmol of benzene ruthenium (II) chloride (dimer) and 30 μmol of bis (diphenylphosphino)methane) were added thereto. The glass vial vial was placed in an autoclave, and the autoclave was sealed and taken out of the glovebox. Thereafter, a stopper of the autoclave was opened, and the reaction mixture was heated to 60° C. and stirred at 800 rpm for 3 hours to perform a formate decomposition reaction. After the reaction, 100 μL of an aqueous DMF solution containing potassium hydrogen carbonate and unreacted potassium formate was dissolved in 500 μL of deuterated water, 300 μL of dimethyl sulfoxide was added as an internal standard, and thereafter, TON of the catalyst was calculated by ¹H NMR measurement. As a result, the TON of the catalyst was 983.

### Composition Analysis of Generated Gas

The components of the mixed gas containing the gas generated by the formate decomposition reaction under the conditions of Example 1 were measured using gas chromatography with a thermal conductivity detector (TCD) (Nexis GC-2030 manufactured by Shimadzu Corporation). As a column, MICROPACKED ST P/N: MP-01 (2.0 m×1.245 mm O.D.×1.0 mm I.D.SUS) was used. As a result, a ratio of hydrogen and carbon dioxide in the mixed gas was 8:2, and generation of hydrogen gas was confirmed.

### Method for Quantifying Formate in Solution

100 μL of a sample solution was dissolved in 500 μL of deuterated water D₂O, and 300 μL of dimethyl sulfoxide DMSO was added as an internal standard, followed by performing ¹H NMR measurement. A molar amount (mol) X of the formate contained in the solution was calculated by the following formula.

$$X = ( W / M ) \times ( Ia \times Ib / R ) \times ( A / B ) \qquad Formula 1$$

(In the formula 1, W represents an amount (g) of dimethyl sulfoxide DMSO used to quantify the formate, M represents a molecular weight of dimethyl sulfoxide DMSO, R represents a ratio of the number of protons of dimethyl sulfoxide to the number of protons of the formate (number of protons of dimethyl sulfoxide/number of protons of formate), Ia represents a proton NMR integration value of the formate, Ib represents a proton NMR integration value of dimethyl sulfoxide DMSO, A represents a mass (g) of the aqueous solution as the lower phase obtained by the above reaction, and B represents a mass (g) of the aqueous solution used to quantify the formate.)

Here, W is 0.33, M is 78.13, and R is 6, and therefore, the following is obtained.

$$X = 0.0 \; 007 \times Ia \times Ib \times ( A / B )$$

### Calculation of Turnover Number (TON) of Catalyst

Calculation of the “TON of catalyst” shown in Table 1 was performed by dividing, by a molar amount (mol) of the Ru catalyst used in the reaction, a value obtained by subtracting a molar amount (mol) of potassium formate or sodium formate quantified after the formate decomposition reaction from 20 mmol, which is the molar amount (mol) of potassium formate or sodium formate before the reaction.

As the TON of the catalyst increases, the number of times of decomposition of the formate per catalyst increases, and the hydrogen yield also increases.

Examples and Comparative Examples are shown in Table 1.

TABLE 1

| | | | | | | | Comparative |
|---|---|---|---|---|---|---|---|
| | Example 1 | Example 2 | Example 3 | Example 4 | Example 5 | Example 6 | Example 1 |
| Reaction | Two-phase | Two-phase | Two-phase | Two-phase | Two-phase | Two-phase | One-phase |
| system | system | system | system | system | system | system | system |
| Phase transfer | Present | Present | Present | Present | Absent | Absent | Absent |
| catalyst | | | | | | | |
| Ru catalyst | Ru | Ru | Ru | Ru | Ru | Ru | Ru |
| | catalyst 1 | catalyst 7 | catalyst 10 | catalyst 1 | catalyst 1 | catalyst 10 | catalyst 10 |
| Solution (mL) | 25 (tolu- | 25 (tolu- | 25 (tolu- | 25 (tolu- | 25 (tolu- | 25 (tolu- | 25 (DMF/ |
| | ene/water = | ene/water = | ene/water = | ene/water = | ene/water = | ene/water = | water = |
| | 4/1) | 4/1) | 4/1) | 4/1) | 4/1) | 4/1) | 4/1) |
| Formate | Potassium | Potassium | Potassium | Sodium | Potassium | Potassium | Potassium |
| | formate | formate | formate | formate | formate | formate | formate |
| Ru catalyst | 5 | 5 | 5 | 5 | 5 | 5 | 5 |
| (μmol) | | | | | | | |
| Concentration | 20 | 20 | 20 | 20 | 20 | 20 | 20 |
| of formate | | | | | | | |
| (mmol) | | | | | | | |
| Reaction | 60 | 60 | 60 | 60 | 60 | 60 | 60 |
| temperature | | | | | | | |
| (° C.) | | | | | | | |
| Reaction | 3 | 3 | 3 | 3 | 3 | 3 | 3 |
| time (hour) | | | | | | | |
| Catalyst | Good | Good | Good | Good | Good | Good | Poor |
| separation | | | | | | | |
| TON | 3,021 | 1,097 | 945 | 2,944 | 705 | 867 | 983 |

In Examples 1 to 6 in which hydrogen was produced using the production method according to the embodiment of the present invention, the reaction was a two-phase system, and therefore, the metal catalyst could be separated from potassium hydrogen carbonate and potassium formate by a simple method, and hydrogen could be produced from a formate with a high yield and excellent productivity. In addition, from the comparison between Example 1 and Example 5 and between Example 3 and Example 6, it was shown that a higher TON was exhibited by using a phase transfer catalyst, and the yield and the productivity were excellent.

### INDUSTRIAL APPLICABILITY

According to the present invention, it is possible to provide a method for producing hydrogen that is capable of producing hydrogen from a formate with a high yield and excellent productivity.

While the present invention has been described in detail with reference to specific embodiments, it will be apparent to those skilled in the art that various changes and modifications can be made without departing from the spirit and scope of the present invention.

The present application is based on a Japanese Patent Application (No. 2021-136535) filed on Aug. 24, 2021, the contents of which are incorporated herein by reference.

1. A method for producing hydrogen, wherein
hydrogen is generated from a formate using a metal catalyst in the presence of a solvent by a two-phase system reaction in which the solvent is present in a state where an organic phase and an aqueous phase are separated.

2. The method for producing hydrogen according to claim 1, wherein
a phase transfer catalyst is used for the reaction.

3. The method for producing hydrogen according to claim 2, wherein
the phase transfer catalyst is a quaternary ammonium salt.

4. The method for producing hydrogen according to claim 1, wherein
the metal catalyst contains at least one metal selected from ruthenium, iridium, iron, nickel, and cobalt.

5. The method for producing hydrogen according to claim 1, wherein
the metal catalyst is at least one selected from a ruthenium complex represented by the following general formula (1), a tautomer or stereoisomer thereof, and a salt compound of the complex, tautomer or stereoisomer: 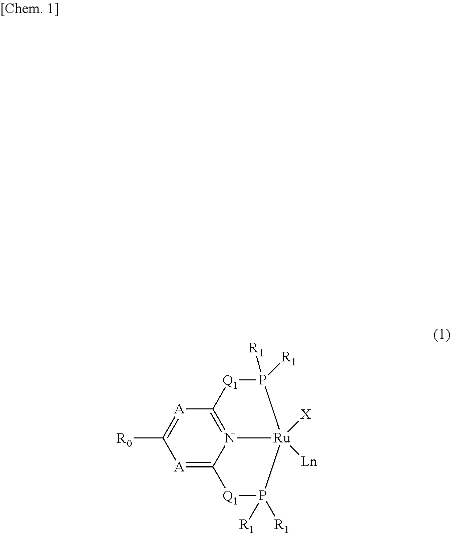
(in the general formula (1), R₀ represents a hydrogen atom or an alkyl group, Q₁ each independently represents CH₂, NH or O, R₁ each independently represents an alkyl group or an aryl group (when Q₁ represents NH or O, at least one of R₁ represents an aryl group), A each independently represents CH, CR₅ or N, R₅ represents an alkyl group, an aryl group, an aralkyl group, an amino group, a hydroxy group, or an alkoxy group, X represents a halogen atom, n represents 0 to 3, and when more than one L are present, L each independently represents a neutral or anionic ligand.)

6. The method for producing hydrogen according to claim 1, wherein
the formate is a sodium formate or a potassium formate.

7. The method for producing hydrogen according to claim 1, wherein
the organic phase contains at least one selected from toluene, dioxane, tetrahydrofuran, ethyl acetate, methylcyclohexane, and cyclopentyl methyl ether.

8. The method for producing hydrogen according to claim 2, wherein
the formate is a sodium formate or a potassium formate.

9. The method for producing hydrogen according to claim 3, wherein
the formate is a sodium formate or a potassium formate.

10. The method for producing hydrogen according to claim 4, wherein
the formate is a sodium formate or a potassium formate.

11. The method for producing hydrogen according to claim 5, wherein
the formate is a sodium formate or a potassium formate.

12. The method for producing hydrogen according to claim 2, wherein
the organic phase contains at least one selected from toluene, dioxane, tetrahydrofuran, ethyl acetate, methylcyclohexane, and cyclopentyl methyl ether.

13. The method for producing hydrogen according to claim 3, wherein
the organic phase contains at least one selected from toluene, dioxane, tetrahydrofuran, ethyl acetate, methylcyclohexane, and cyclopentyl methyl ether.

14. The method for producing hydrogen according to claim 4, wherein
the organic phase contains at least one selected from toluene, dioxane, tetrahydrofuran, ethyl acetate, methylcyclohexane, and cyclopentyl methyl ether.

15. The method for producing hydrogen according to claim 5, wherein
the organic phase contains at least one selected from toluene, dioxane, tetrahydrofuran, ethyl acetate, methylcyclohexane, and cyclopentyl methyl ether.
